(19) United States
(12) Patent Application Publication
(10) Pub. No.: US 2025/0027884 A1
(43) Pub. Date: Jan. 23, 2025

(54) SYSTEMS AND METHODS FOR TRANSLATIONAL TRIGGERING FOR IMAGE-BASED INSPECTION OF OBJECTS

(71) Applicant: COGNEX CORPORATION, NATICK, MA (US)

(72) Inventors: Eric Moore, Boulder, CO (US); Sebastian Mock, Erfurt (DE)

(21) Appl. No.: 18/781,336

(22) Filed: Jul. 23, 2024

Related U.S. Application Data
(60) Provisional application No. 63/515,112, filed on Jul. 23, 2023.

(51) Int. Cl. G01N 21/88; G01N 21/84

(52) U.S. Cl. CPC G01N 21/8851; G01N 2021/8455; G01N 2021/887; G01N 2021/8887; G01N 2201/121

(57) ABSTRACT

Systems and associated methods and/or utilize a 3D area-scan camera having a FOV and positioned to include a portion of a transport device within the FOV, and configured to capture images in accordance with a known interval; and at least one processor in communication with the 3D area-scan camera, and configured to: receive the images, extract image data associated with the object from the images, and analyze the image data and provide an inspection result corresponding to the object.

### CROSS-REFERENCE TO RELATED APPLICATIONS

This application claims priority to and the benefit of U.S. Provisional Application No. 63/515,112, filed on Jul. 23, 2023, the entire contents of which are herein incorporated by reference.

### STATEMENT REGARDING FEDERALLY FUNDED RESEARCH

Not applicable.

### BACKGROUND

Machine vision is often used to provide information about objects moving on a transport device, such as a conveyor belt. For example, machine vision cameras might read barcodes on product packaging, measure the dimensions of parcels, inspect manufactured goods for defects, and so on. However, systems that include machine vision inspection of conveyed objects may suffer when objects move past any given point along the conveyor at a rate (the “object rate”) that is higher than the maximum image capture rate of the machine vision camera. A need exists for improved machine vision approaches that enable the machine vision systems to operate at an effective object rate that exceeds the maximum image capture rate of the machine vision camera.

### SUMMARY

In an aspect, the present disclosure provides a system for inspecting an object moving on a transport device. The system comprises a signaling device configured to output a signal indicative of a location of the object relative to a portion of the transport device; a 3D area-scan camera having a field of view (FOV) and positioned to include the portion of the transport device within the FOV, and configured to capture images in accordance with a known interval and irrespective of the signal; and at least one processor in communication with the signaling device and the 3D area-scan camera, and configured to: receive the images, based on the signal, extract image data associated with the object from the images, and analyze the image data and provide an inspection result corresponding to the object.

In another aspect, the present disclosure provides a method for inspecting an object moving on a transport device. The method comprises generating a signal indicative of a location of the object relative to a portion of the transport device; receiving images captured by a 3D area-scan camera, the 3D area-scan camera having a field of view (FOV) and being positioned to include the portion of the transport device within the FOV, wherein consecutive images are captured in accordance with a known interval irrespective of the signal; based on the signal, extracting image data associated with the object from the sequence of first images, and analyzing the image data and providing an inspection result corresponding to the object.

In another aspect, the present disclosure provides a system for inspecting an object moving on a transport device. The system comprises a first 3D area-scan camera having a field of view (FOV) and positioned to include a first portion of the transport device within a field of view of the first 3D area-scan camera the FOV, and configured to capture a plurality of first images respectively separated by known first intervals in accordance with a known interval; and at least one processor in communication with the 3D area-scan camera, and configured to: receive the images, combine multiple of the images to yield a resultant image, extract image data associated with the object from the resultant image, and analyze the image data and provide an inspection result corresponding to the object.

In another aspect, the present disclosure provides a method for inspecting an object moving on a transport device. The method comprises receiving images captured by a 3D area-scan camera, the 3D area-scan camera having a field of view (FOV) and being positioned to include a portion of the transport device within the FOV, wherein consecutive images are captured in accordance with a known interval; combining multiple images to yield a resultant image; extracting image data associated with the object from the images; and analyzing the image data and providing an inspection result corresponding to the object.

Any citations to publications, patents, or patent applications herein are incorporated by reference in their entirety. Any numerals used in this application with or without about/approximately are meant to cover any normal fluctuations appreciated by one of ordinary skill in the relevant art.

Other features, objects, and advantages of the present invention are apparent in the detailed description that follows. It should be understood, however, that the detailed description, while indicating embodiments of the present invention, is given by way of illustration only, not limitation. Various changes and modifications within the scope of the invention will become apparent to those skilled in the art from the detailed description.

### BRIEF DESCRIPTIONS OF THE DRAWINGS

FIG. 1 is schematic of a comparative example of a machine vision system in the related art.

FIG. 2A is a schematic of a machine vision system in accordance with aspects of the present disclosure.

FIG. 2B is a schematic of a machine vision system in accordance with aspects of the present disclosure.

FIG. 3 is a partial perspective view of a machine vision system in accordance with aspects of the present disclosure.

FIGS. 4A-4D are schematic representations of image capture operations in accordance with aspects of the present disclosure.

FIG. 5A is a schematic of another machine vision system in accordance with aspects of the present disclosure.

FIG. 5B is a schematic of another machine vision system in accordance with aspects of the present disclosure.

FIG. 6A is a front view schematic of another machine vision system in accordance with aspects of the present disclosure.

FIG. 6B is a front view schematic of another machine vision system in accordance with aspects of the present disclosure.

FIG. 7 is a flowchart illustrating a method in accordance with aspects of the present disclosure.

### DETAILED DESCRIPTION

Before the present invention is described in further detail, it is to be understood that the invention is not limited to the particular embodiments described. It is also to be understood that the terminology used herein is for the purpose of describing particular embodiments only, and is not intended to be limiting. The scope of the present invention will be limited only by the claims. As used herein, the singular forms “a,” “and,” and “the” include plural embodiments unless the context clearly dictates otherwise.

It should be apparent to those skilled in the art that many additional modifications beside those explicitly described are possible without departing from the inventive concepts. In interpreting this disclosure, all terms should be interpreted in the broadest possible manner consistent with the context. Variations of the term “comprising,” “including,” or “having” should be interpreted as referring to elements, components, or steps in a non-exclusive manner, so the referenced elements, components, or steps may be combined with other elements, components, or steps that are not expressly referenced. Embodiments referenced as “comprising,” “including,” or “having” certain elements are also contemplated as “consisting essentially of” and “consisting of” those elements, unless the context clearly dictates otherwise. It should be appreciated that aspects of the disclosure that are described with respect to a system are applicable to the methods, and vice versa, unless the context explicitly dictates otherwise.

Numeric ranges disclosed herein are inclusive of their endpoints. For example, a numeric range of between 1 and 10 includes the values 1 and 10. When a series of numeric ranges are disclosed for a given value, the present disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

As used herein, the terms “component,” “system,” “device” and the like are intended to refer to either hardware, firmware, software, software in execution, or any combination thereof. The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques and/or programming to produce hardware, firmware, software, or any combination thereof to control an electronic based device to implement aspects detailed herein.

Unless specified or limited otherwise, the terms “connected,” “coupled” and variations thereof are used broadly and encompass both direct and indirect mountings, connections, supports, and couplings. Further, “connected” and “coupled” are not restricted to physical or mechanical connections or couplings. As used herein, unless expressly stated otherwise, “connected” means that one element/feature is directly or indirectly connected to another element/feature, and not necessarily electrically or mechanically. Likewise, unless expressly stated otherwise, “coupled” means that one element/feature is directly or indirectly coupled to another element/feature, and not necessarily electrically or mechanically.

As used herein, the term “processor” may include one or more processors and memories and/or one or more programmable hardware elements. As used herein, a “processor” may include one or more processing cores. As used herein, the term “processor” is intended to include any of types of processors, central processing units (CPUs), graphics processing units (GPUs), microcontrollers, digital signal processors, or other devices capable of executing software instructions.

As used herein, the term “memory” includes a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; or an installation medium, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory.

In comparative examples of systems that include machine vision inspection of conveyed objects, operations typically occur in the following manner. A series of objects travel along a conveyor, and one or more cameras are mounted such that they form images of a portion of the conveyor. For each object traveling on the conveyor, a trigger signal is generated such that an image is acquired by the camera(s) while the object is present within the portion of the conveyor covered by the field of view of the camera(s). The object rate (i.e., the rate at which objects move past any given point along the conveyor) is determined by the speed of the conveyor, the sizes of the objects being conveyed, and the spacings between the objects. Generally, the object rate may vary over time.

In such a system, the rate at which the cameras must acquire images is equal to the object rate. However, in certain systems, it may be desirable for the object rate to exceed the maximum image acquisition rate for a camera. In this case, the camera may be unable to capture images frequently enough to permit inspection of all objects on the conveyor. Some comparative systems have attempted to address this problem by using cameras with higher image acquisition rates; however, such cameras are generally much more expensive and lead to higher overall system costs. Even these expensive systems may be unable to address the problems caused by a high or temporarily-high object rate, for example if a camera with the required imaging properties is not available with the required image acquisition rate. These issues are especially likely to occur in three-dimensional (3D) machine vision applications, as 3D machine vision sensors may be subject to more limited image acquisition rates in comparison to standard two-dimensional (2D) cameras.

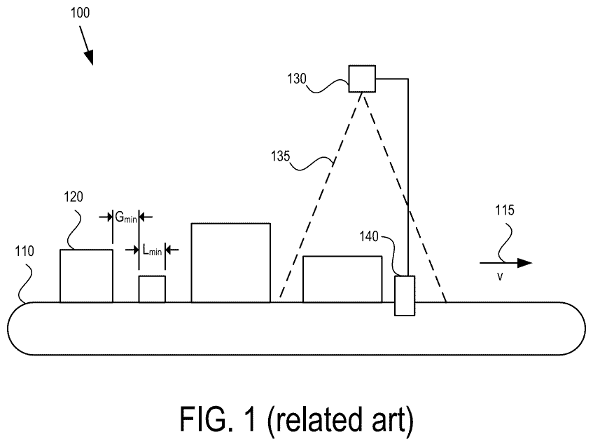

Referring to FIG. 1, a comparative example machine vision system 100 is illustrated. The comparative system 100 includes a transport device 110 implemented as a conveyor belt, on which a series of objects 120 travel in a travel direction 115. A camera 130 is disposed above the transport device 110 and images in a field of view 135. An object detection device 140, such as a photoeye, is operably connected to the camera 130. The object detection device 140 is tripped/activated by the leading edge of each object 120, and in response produces a trigger signal for each object 120. The trigger signal causes the camera 130 to perform an image capture operation; thus, an image is acquired by the camera 130 at a moment in time when the object 120 lies within the field of view 135. Images acquired by the camera 130 are processed to perform an inspection of the object 120.

As shown in FIG. 1, the objects 120 may have a wide variety of dimensions. In such a system, the maximum rate Rₘₐₓ at which images must be acquired is determined by the minimum time between respective leading edges of the objects 120. The minimum time is determined by the speed v of the transport device 110, the minimum length Lₘᵢₙ in the travel direction 115 of objects 120 on the transport device 110, and the minimum gap size Gₘᵢₙ between adjacent objects 120, according to the expression Rₘₐₓ=v/(Lₘᵢₙ+Gₘᵢₙ). The parameters Lₘᵢₙ and Gₘᵢₙ are generally known to an operator of the comparative system 100. If the speed v becomes sufficiently large, or the sum of the parameters Lₘᵢₙ and Gₘᵢₙ are sufficiently small, then Rₘₐₓ may exceed the capabilities of the camera 130, thus causing some of the objects 120 to not be imaged or not be sufficiently imaged to permit inspection.

Notably, there is a strong desire by system end-users to decrease Gₘᵢₙ, and increase the speed v of the transport device 110. Increasing v and/or minimizing Gₘᵢₙ causes a higher overall throughput of the system. However capabilities of the camera 130 in the comparative system 100 can limit the flexibility of v and/or Gₘᵢₙ in order to achieve an Rₘₐₓ that does not exceed the acquisition rate of the camera 130.

The systems, devices, and methods described in the present disclosure enable machine vision rates to operate at object rates that exceed the image acquisition rate of the camera or sensor for a broad class of applications. This in turn enables machine vision to address a wider variety of applications involving conveyed objects, and reduces the cost and increases the availability of such systems.

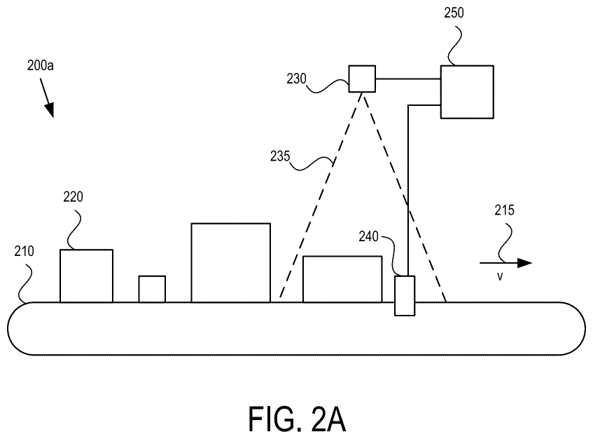

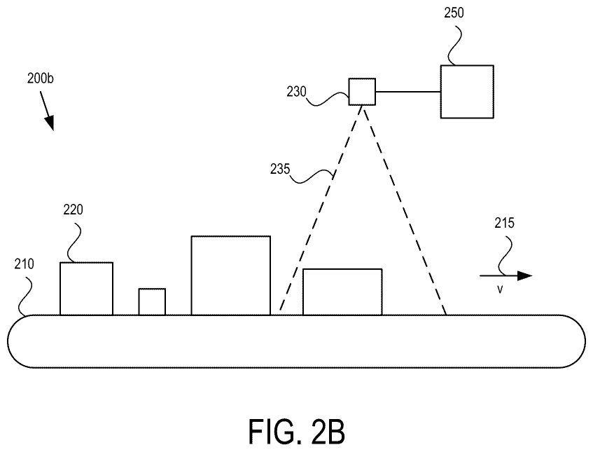

Referring to FIG. 2A, a machine vision system 200a in accordance with the present disclosure is illustrated. The system 200a includes a transport device 210 which conveys a series of objects 220 in a travel direction 215 at a speed v. A camera 230 is disposed above the transport device 210 and images within a field of view 235. The system 200a further includes a signaling device 240, which may include an object detection device such as a photoeye, and a processor 250. The processor 250 is operably connected to both the camera 230 and the signaling device 240. The signaling device 240 is configured to output a signal, the signal being configured to indicate a location of the object 220 relative to a particular portion of the transport device 210. In this usage, a location of the object 220 “relative to” another location means a position of the object 220 upstream from (i.e., in a direction opposite the travel direction 215) the location, downstream from (i.e., in the travel direction 215) the location, or within a span of the location (e.g., within the field of view 235). Thus, the signaling device 240 may be placed at any location along the transport device 210, including locations upstream or downstream from the position illustrated in FIG. 2A. Unlike the comparative system 100, which relies on an object detection device 140 to trigger an image capture operation, the system 200a does not use an object detection device to trigger an image capture operation. Instead, the camera 230 is configured to capture, irrespective of triggering, a plurality of images respectively separated by known intervals. An interval may be “known” if it is based on pre-capture knowledge and/or post-capture knowledge. In some examples, the known intervals may vary between image captures and thus not be constant (e.g., if the speed of the transport device 210 is not constant). Thus, even in implementations in which the system 200a includes an object detection device, the object detection device is not used to trigger the camera 230.

Referring to FIG. 2B, a machine vision system 200b in accordance with the present disclosure is illustrated. The system 200b includes a transport device 210 which conveys a series of objects 220 in a travel direction 215 at a speed v. A camera 230 is disposed above the transport device 210 and images within a field of view 235. The system 200b further includes a processor 250. The processor 250 is operably connected to the camera 230. Compared to the system 200a of FIG. 2A, the system 200b does not include a signaling device. Unlike the comparative system 100, which relies on an object detection device 140 to trigger an image capture operation, the system 200b does not use an object detection device to trigger an image capture operation. Instead, the camera 230 is configured to capture, irrespective of triggering, a plurality of images respectively separated by known intervals. An interval may be “known” if it is based on pre-capture knowledge and/or post-capture knowledge. In some examples, the known intervals may vary between image captures and thus not be constant (e.g., if the speed of the transport device 210 is not constant). Thus, even in implementations in which the system 200b includes an object detection device, the object detection device is not used to trigger the camera 230.

Various components of the system 200a and the system 200b are illustrated as separate entities for ease of explanation, but the present disclosure is not so limited. In examples, the camera 230, the signaling device 240 (if present), and the processor 250 may be combined into a single housing to provide a unitary inspection apparatus. In other examples, the camera 230, the signaling device 240 (if present), or the processor 250 may be a separate entity to provide a modular inspection apparatus. In still other examples, each of the camera 230, the signaling device 240 (if present), and the processor 250 may be separate entities. In some implementations of the system 200a, the signaling device 240 may be replaced by a software component (e.g., implemented on another device, such as the camera 230, another camera, a dimensioner, etc.), which is capable of determining a position of the object 220, a position of a leading edge of the object 220, a position of the trailing edge of the object 220, or combinations thereof. Where the camera 230 or other device performs the function of the signaling device 240 in such examples, it may in some examples do so in conjunction with the processor 250. In one particular example of an implementation of the system 200b in which a separate signaling device 240 is omitted, the camera 230 may include a first image sensor configured to capture relatively high-speed and low-resolution images and a second image sensor configured to capture relatively low-speed and high-resolution images, in which “relative” is with respect to the other image sensor. The first and second image sensors may be included in the same housing or device, or in separate housings or devices. In this example, the images captured by the first image sensor may be used to indicate the location of the object relative to the portion of the transport device 210 within the field of view 235, and the images captured by the second image sensor may be used to perform inspection.

The camera 230, the signaling device 240 (if present), and the processor 250 may be connected to one another by wired communication links, by wireless communication links, or both. Wired links include Ethernet links, optical fiber links, serial links such as RS-232 or Fire Wire links, parallel links, Peripheral Component Interconnect (PCI) links, and the like. Wireless links include Wi-Fi links such as those that implement Institute of Electronics and Electrical Engineers (IEEE) 802.11 protocols, including 802.11, 802.11b, 802.11a, 802.11g, 802.11n, 802.11ac, 802.11ax, 802.11be; Bluetooth (R) links, Near Field Communication (NFC) links; and the like.

The transport device 210 may be any device configured to or capable of conveying items thereon. In some examples, the transport device 210 may be a conveyor belt, a roller conveyor, a tray sorter or other sortation system, any other conveyor, a mobile robot, a fork truck, a flatbed truck or trailer, any other device or vehicle for transporting objects, or any combination of the foregoing.

The objects 220 may be any objects that are, or are capable of being, inspected by a machine vision system. For example, the objects 220 may be manufactured parts, packaged goods, raw materials, shipping parcels, foodstuffs, or any other object that may be visually inspected or characterized by non-contact optical inspection. While FIGS. 2A-B illustrate the objects 220 as being substantially cuboids or other rectangular prisms, the present disclosure is not so limited. In practical implementations, the objects 220 may take any shape. Moreover, while FIGS. 2A-B illustrate a plurality of objects 220, the system 200a/b may also operate with only a single object 220. Notably, the objects 220 may have any orientation relative to the transport device 210, the direction of travel 215, and/or position of the camera 230.

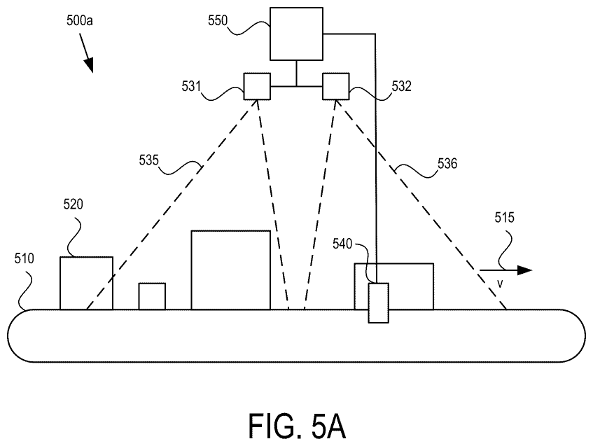

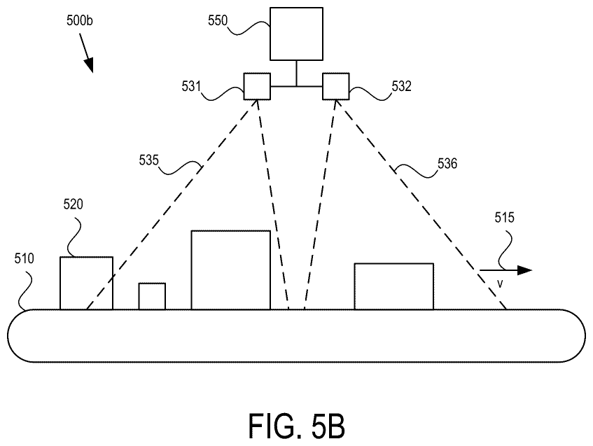

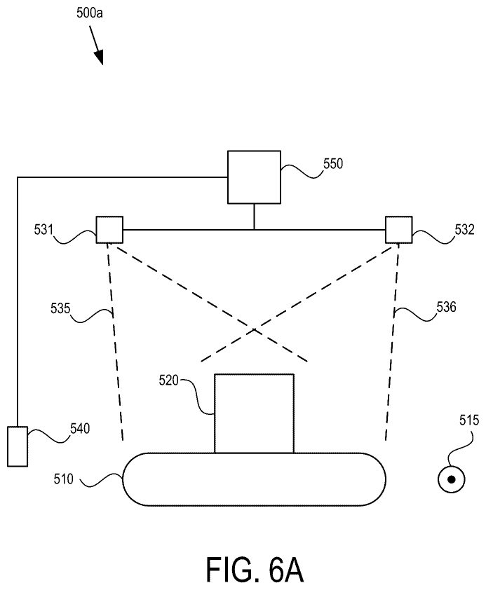

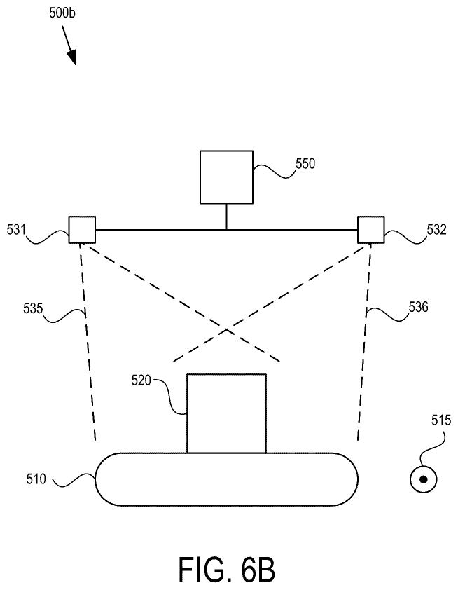

The camera 230 is mounted above a surface of the transport device 210 and oriented toward the transport device 210. Preferably, the camera 230 is mounted such that its field of view 235 includes a portion of the surface of the transport device 210. While FIGS. 2A-B illustrate the camera 230 being oriented directly toward the transport device 210 such that a central axis of the cone of the field of view 230 is normal to the surface of the transport device 210, in practical implementations the camera 230 may be oriented obliquely so as to image side surfaces of the objects 220 in addition to or instead of top surfaces of the objects 220. The camera 230 may be a machine vision camera capable of capturing 2D images, although preferably the camera 230 is a 3D area-scan camera, such as a 3D-A1000 dimensioning system provided by Cognex Corporation of Natick, Massachusetts. In either case, the images captured by the camera 230 may be 3D images, 2D images, or both 3D and 2D images. As used herein, a “3D area-scan camera” refers to a 3D camera with a field of view that covers an area with extent on both dimensions orthogonal to the camera's nominal optical axis. A 3D area-scan camera as used herein is thus distinct from 3D sensors such as laser line displacement sensors, which capture a field of view with an extent in only one dimensions orthogonal to a nominal sensor optical axis. While FIGS. 2A-B illustrate only a single camera 230, the present disclosure may include multiple cameras each of which form images of the conveyed object. One such example will be described in more detail below with regard to FIGS. 5-6.

Returning to FIGS. 2A-B, the processor 250 may be one or more electronic processors, each of which includes one or more processing cores. The processor 250 may include or be associated with one or more memory elements. The processor 250 may be configured to execute instructions in the form of transitory signals and/or non-transitory computer-readable media, such as the one or more memory elements. By executing the instructions, the processor 250 is configured to cause the system 200a and/or the system 200b to perform one or more operations, including computing processes, image capture processes, image processing processes, inspection processes, and combinations thereof. The inspection processes may include dimensional measurement, detection of defects, determination of an object's location on the transport device, reading codes or characters, or any other inspection process as described herein.

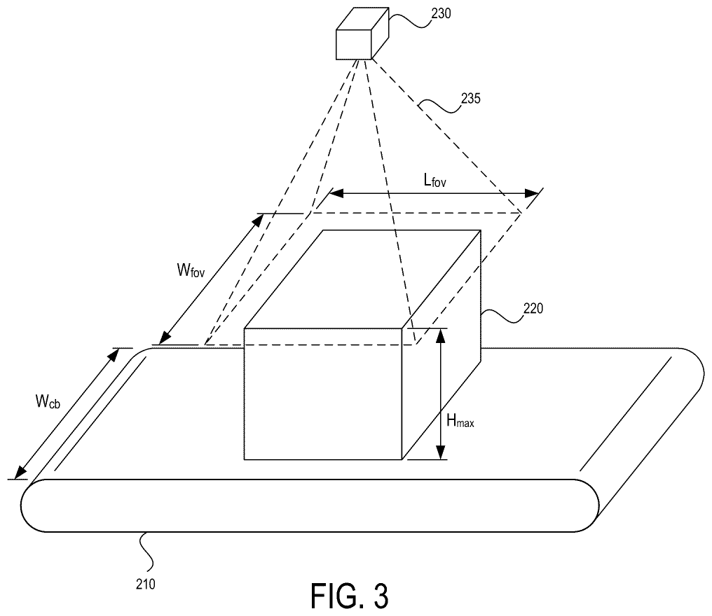

The field of view 235 may be selected to be any size. Preferably, however, where the system 200a and/or the system 200b is a single-camera system the field of view 235 is selected such that it covers the full width of the transport device 210 at a height greater than or equal to the tallest object 220 to be inspected (i.e., the maximum expected height). For a camera 230 which has a field of view 235 having an aspect ratio predetermined by its image sensor, its optical system design, or other factors, this choice of field of view 235 will set the length of the area of the transport device 210 that is viewed within each image acquired by the camera 230. This is shown in more detail in FIG. 3.

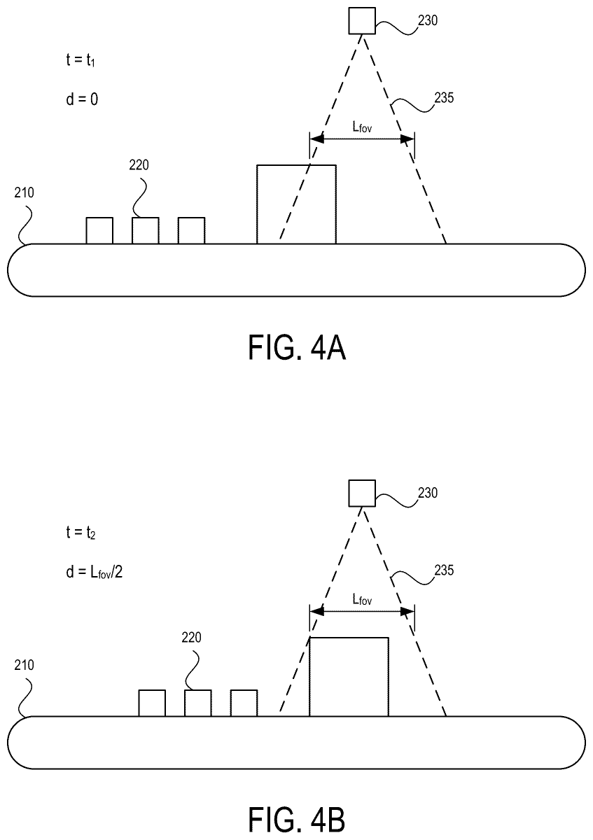

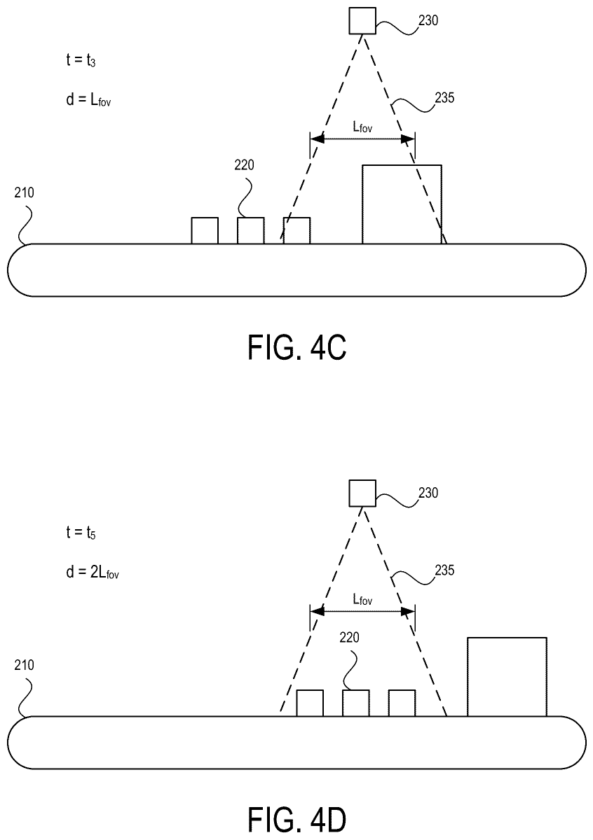

In FIG. 3, a portion of the transport device 210 is illustrated with a single object 220 corresponding to a tallest object of the objects 220 shown in FIGS. 2A-B, at a point in time at which the object 220 is within the field of view 235 of the camera 230. For clarity, FIG. 3 omits the signaling device 240 and the processor 250. The transport device 210 has a width Web. Thus, the “width” direction is considered to be the direction perpendicular to the travel direction 215 (see FIGS. 2A-B) and coplanar with the surface of the transport device 210. The object 220, being the tallest of the objects 220 under inspection, has a height Hₘₐₓ corresponding to the maximum expected height. Thus, the “height” direction is considered to be the direction perpendicular to the travel direction 215 and normal to the surface of the transport device 210. The field of view 235, measured at the height Hₘₐₓ, has a width W_{fov} and a length L_{fov}. Thus, the “length” direction is considered to be the direction parallel to the travel direction 215. The width W_{fov} may be greater than or equal to the width W_{cb} to ensure that the single camera 230 is capable of imaging the entire breadth of the transport device 210 and/or any object 220 thereon. The length L_{fov} may be longer, shorter, or equal to the longest one of the objects 220 to be inspected by the system 200a/b. While the field of view 235 is illustrated as rectangular, the field of view 235 may take any shape or orientation. For example, if the field of view 235 were rotated 45° about the central axis of the field of view 235, the width W_{fov} may be measured along the diagonal. Multiple objects 220 may simultaneously fit into the field of view 235 at once, as will be described in more detail below with regard to FIGS. 4A-D. Further, multiple objects 220 may be positioned next to one another with respect to the width of the transport device 210. While FIG. 3 illustrates an example in which the field of view 235 has a rectangular cross-section, in practical implementations the field of view 235 may have a cross-section of any shape.

The camera 230 is configured to acquire a plurality of images in sequence. For implementations in which the camera 230 is a 3D camera, the resulting (e.g., acquired) images may be point clouds, meshes, range images, depth maps, or any other 3D data representation. Any image of the plurality of images may include any number of objects, including zero, one, more than one, and/or fractions of objects at the boundaries of the field of view 235. As noted above, the length L_{fov} may be shorter than the longest one of the objects 220 to be inspected by the system 200a/b; thus, the largest object 220 to be inspected may or may not fit within a single image. Consecutive ones of the plurality of images are separated by a known interval. The magnitude of an interval may be considered “known” if it is set prior to image capture, for example by being predetermined or measured, rather than the image capture being performed in response to an object detection as is the case in the comparative system. In some implementations, the intervals are time intervals corresponding to a time elapsed between capture of consecutive ones of the plurality of images. The time intervals may be regular, such that the time elapsed is the same or substantially the same between each consecutive pairs of images. Alternatively, the time intervals may be irregular. Where the intervals are irregular, the camera 230 may be in communication with (e.g., connected via either a wired or wireless connection) an encoder or other device for measuring the distance traveled by the transport device 210, thereby ensuring that the images are acquired at regular intervals of conveyed distance despite being acquired at irregular intervals of time. If the intervals are irregular, the interval may be measured, for example as a time stamp or encoder value associated with each image in the sequence.

In other implementations, the intervals may be distance intervals corresponding to a distance traveled by the transport device between capture of consecutive images. This may be accomplished by acquiring images at equal intervals of time in conjunction with a conveyor moving at a constant speed. Alternatively, the camera 230 may be in communication with an encoder or other device for measuring the distance traveled by the transport device 210, and may be configured to capture an image when the transport device 210 has moved by an amount corresponding to the distance interval. Where the interval is a distance interval, the interval may be such that the distance traveled by a portion of the transport device 210 between the capture of consecutive images is less than or equal to the length L_{fov} measured at a predetermined height above a surface of the transport device 210, which is greater than or equal to the height Hₘₐₓ (see FIG. 3). In such implementations, the distance traveled may be (1/n) time the length L_{fov}, where n is an integer greater than or equal to one. In particular implementations, n may be 2, 3, or 10, such that the distance traveled is one-half, one-third, or one-tenth the length L_{fov}, although the distance traveled is not limited to these particular examples and may be any fraction of the length L_{fov} including the fraction (1/1) and fractions in which n is not an integer.

By setting the interval to be a fraction of the length L_{fov}, the system 200a/b ensures that each object 220 is imaged multiple times as it passes through the field of view 235 of the camera 230. For example, if the distance interval is one-half of the length L_{fov}, then each object 220 will appear in at least two images. Similarly, if the distance interval is one-tenth of the length L_{fov}, each object 220 will appear in at least ten images. Because the length L_{fov} is measured at the height Hₘₐₓ, in practice those objects 220 which are shorter than the tallest object 220 may appear in a larger number of the images.

In implementations, the processor 250 may be configured to receive the plurality of images. The images may be received, either directly or indirectly, from the camera 230. The processor 250 may be configured to receive a signal from the signaling device 240 if the signaling device 240 is present, wherein the signal is configured to indicate that an object 220 is present on a first portion of the transport device 210 (e.g., a portion of the transport device 210 within the field of view 235) or to indicate a location of the object 220 relative to the first portion of the transport device 210. The processor 250 is configured to, based on the signal, extract image data associated with the object 220 from the plurality of images, and to inspect the object 220 based on the image data. The processor 250 may additionally be configured to combine at least two of the plurality of images to yield a resultant image. In some implementations, the resultant image includes a larger portion of the object than individual ones of the plurality of first images. For example, the resultant image may sample a larger sampling area than any single image, may include sides of the object 220 within the same sampling area or volume which would be occluded in a single image, or both. If the object 220 is larger than the field of view 235, the resultant image may show the entire object 220 even though any single image only shows a portion of the object 220. The processor 250 may be configured to detect the presence of the object 220 in the resultant image, and to inspect the object 220 based on the resultant image.

Because the system 200a/b provides multiple images of each object 220, the system 200a/b provides several benefits over comparative systems, such as the comparative system 100. For example, inspections may be repeated for each image of the object 220, thereby providing increased precision, accuracy, and/or confidence in the inspection result. Moreover, different images of the same object 220 may include views of the object 220 under different lighting conditions. Thus, in instances where the quality of images provided by the camera 230 is dependent on the lighting conditions and the lighting conditions vary throughout the field of view 235, the multiple images may result in inspections that are more precise, accurate, and/or robust. Furthermore, the presence of multiple images may provide increased sampling density on the surface of the object 220, leading to improved inspection results. Additionally, if a portion of an object 220 is occluded in one image, additional images may provide the ability to visualize the occluded portion of the object 220.

To illustrate some of the above benefits, consider an implementation in which the camera 230 is a 3D-A1000 dimensioning system provided by Cognex Corporation of Natick, Massachusetts, as described above. Referring to FIGS. 4A-4D, a partial time sequence of image capture events in the system 200a/b is illustrated for this example. In FIGS. 4A-4D, only the transport device 210, a subset of objects 220, and the camera 230 with its field of view 235 are illustrated. The other portions of the system 200a/b, shown in FIGS. 2A-B, are omitted for purposes of clarity and ease of explanation. Each of FIGS. 4A-4D illustrate the configuration of the system 200a/b at a point in time corresponding to a different image capture operation, for a particular example in which the distance interval is one-half of the length L_{fov}.

FIG. 4A illustrates the system 200a/b at time t₁ corresponding to a first image capture, in which the transport device 210 has not moved and thus the distance corresponds to a reference distance denoted as 0. FIG. 4B illustrates the system 200a/b at a time t₂ corresponding to a second image capture, in which the transport device 210 has moved a distance Low/2 compared to the reference distance. FIG. 4C illustrates the system 200a/b at a time t₃ corresponding to a third image capture, in which the transport device 210 has moved a distance L_{fov} compared to the reference distance. FIG. 4D illustrates the system 200a/b at a time t₅ corresponding to a fifth image capture, in which the transport device 210 has moved a distance 2L_{fov} compared to the reference distance.

The 3D-A1000 dimensioning system employs a system called “structured light” or “symbolic light” for capturing point clouds. The symbolic light system provides its own lighting in the form a projected pattern of infrared light. Depending on the surface geometry and material qualities of an object being inspected, the projected light may be diffusely scattered, specularly reflected, or both. Further details of the symbolic light system are provided in U.S. Pat. No. 10,699,429, titled “Coding Distance Topologies for Structured Light Patterns for 3D Reconstruction,” and which is incorporated by reference herein. For surfaces that are partially or fully specular, the reflected light may or may not reach the image sensor of the camera depending on the location and orientation of the object within the field of view. For example, a partially specular surface at the edge of the field of view (e.g., the top surface of the large object in FIG. 4A) may direct most of the reflected light away from the image sensor, leading to a low signal return level and difficulty or failure in reconstructing 3D points. The same surface near the center of the field of view (e.g., the top surface of the large object in FIG. 4B and/or FIG. 4C), on the other hand, may direct relatively more reflected light to the image sensor, resulting in a higher signal return level and a corresponding increase in the number of reconstructed 3D points. If multiple images of the object are taken at different points in the field of view, and thus under different lighting conditions by the symbolic light, there is an increased likelihood that the specular regions will provide sufficient signal in at least one image. These benefits are especially pronounced in 3D dimensioning systems, for example because the illumination pattern and arrangement may be fixed for a given 3D camera with little to no flexibility to modify based on the objects being imaged (i.e., it may be difficult or impossible for a user to change the position or orientation of the light projector). However, the present disclosure provides benefits even in 2D dimensioning systems as a result of generating images under different lighting conditions.

The 3D-A1000 dimensioning system samples its field of view at discrete points defined by the projected infrared pattern. These sampled points are not immediately adjacent to one another, so there are object surface regions between the points that remain unsampled by a single image acquisition. Furthermore, the discrete points are arranged in an irregular manner that varies over the field of view. If multiple images are acquired as an object traverses the field of view on the transport device, each image samples a different set of the discrete points on the object surface. Thus, taken together, multiple images (e.g., by combining the images acquired as shown in FIGS. 4A-4C) result in a denser sampling of points as compared to any single image. In some implementations of the system 200a/b, knowledge of the distance interval between acquisitions may be used to transform point cloud data into a common object-based coordinate system to produce a merged point cloud representation with a higher point density than single acquisitions. This higher density may in turn lead to higher accuracy inspections. For dimensional measurements of shipping parcels, for example, accuracy may depend on how closely the point cloud samples the edges of the parcel faces. The higher density point clouds that result from merging multiple point clouds derived from the sequence of images can thus lead to higher accuracy dimension measurements.

Where the system is used to inspect cuboidal objects such as shipping parcels, occlusion may occur. For example, if a single image of a parcel is acquired from directly above the parcel and the parcel is near the center of the field of view, the side faces of the parcel may be occluded by the top face (e.g., the top surface of the large object in FIG. 4B). However, if additional images are acquired as the parcel enters and exits the field of view and/or as it moves along the conveyor, it is likely that the front and back of the parcel will be visible in one or more of the additional images (e.g., the images acquired as shown in FIG. 4A and/or FIG. 4B). This allows for additional inspections, such as defect detection or code reading, to take place for the front and back faces, which would not have been possible with a single image per parcel.

In addition to the benefits provided by capturing multiple images of each object 220, the system 200a/b provides benefits by capturing images at known intervals rather than capturing images based on a trigger signal caused by the leading edge of each object. For example, where a single image capture operation captures multiple comparatively small objects (e.g., the images acquired as shown in FIG. 4D), it is possible for the effective object sampling rate to exceed the maximum capture rate of the camera. If the camera were configured to capture images based on the trigger signal, as in the comparative system 100, the camera would not be able to capture images sufficiently quickly. The capturing of images at known intervals may provide additional benefits for 3D applications. For example, the processes of merging images and extracting data corresponding to objects is facilitated by the fact that 3D data can be represented in a rectilinear, Cartesian coordinate system. This facilitates with separating object data because, for examples which include a signaling device 240, the signal from the signaling device 240 can be mapped to planes in 3D space that delimit the front and back surfaces of the object. Conversely, 2D images typically include perspective distortion, which results in variable positions of object edges within the images depending on the height of the object 220. Perspective distortion may also cause adjacent objects to overlap in the captured images if the gap between the adjacent objects is not near the center of the field of view 235. Therefore, merging 2D images present certain challenges, and the signal from the signal device 235 may be difficult to map to object boundaries in a merged image.

The above examples of benefits are not exhaustive, mutually exclusive, or limiting, and the system 200a/b may provide further benefits not expressly discussed here. Moreover, the above benefits are not limited to any particular 3D dimensioning system such as the 3D-A1000 dimensioning system, and are generally applicable to other types of 3D cameras.

Referring to FIGS. 5A and 6A, a machine vision system 500a in accordance with the present disclosure is illustrated. In FIG. 5A, a side view of the system 500a is shown, whereas in FIG. 6A, a front view of the system 500a is shown. The system 500a includes a transport device 510 which conveys a series of objects 520 in a travel direction 515 at a speed v. A first camera 531 and a second camera 532 are disposed above the transport device 510, such that the first camera 531 images within a first field of view 535 and the second camera 532 images within a second field of view 536. While FIG. 5A illustrates only two cameras, one or more additional cameras may be provided with additional respective fields of view. The system further includes a signaling device 540, which may include an object detection device such as a processor 550. The processor 550 is operably connected to each of the first camera 531, the second camera 532, and the signaling device 540. The signaling device 540 is configured to output a signal, the signal being configured to indicate a location of the object 520 relative to a particular portion of the transport device 510. In this usage, a location of the object 520 “relative to” another location means a position of the object 520 upstream from (i.e., in a direction opposite the travel direction 515) the location, downstream from (i.e., in the travel direction 515) the location, or within a span of the location (e.g., within the first field of view 535 or the second field of view 536). Thus, the signaling device 540 may be placed at any location along the transport device 510, including locations upstream or downstream from the position illustrated in FIG. 5A. Thus, while FIG. 5A illustrates the signaling device 540 located within the second field of view 536, in practical implementations the signaling device 540 may be located at any point. Moreover, while FIG. 5A illustrates the first field of view 535 and the second field of view 536 as being non-overlapping, the first field of view 535 and the second field of view 536 may be partially or entirely overlapping.

Referring to FIGS. 5B and 6B, a machine vision system 500b in accordance with the present disclosure is illustrated. In FIG. 5B, a side view of the system 500b is shown, whereas in FIG. 6B, a front view of the system 500b is shown. The system 500b includes a transport device 510 which conveys a series of objects 520 in a travel direction 515 at a speed v. A first camera 531 and a second camera 532 are disposed above the transport device 510, such that the first camera 531 images within a first field of view 535 and the second camera 532 images within a second field of view 536. While FIG. 5B illustrates only two cameras, one or more additional cameras may be provided with additional respective fields of view. The system further includes a processor 550. The processor 550 is operably connected to the first camera 531 and the second camera 532. Compared to the system 500a, the system 500b does not include a signaling device. Moreover, while FIG. 5A illustrates the first field of view 535 and the second field of view 536 as being non-overlapping, the first field of view 535 and the second field of view 536 may be partially or entirely overlapping.

Similar to the system 200a/b, and unlike the comparative system 100, the system 500a/b does not use an object detection device to trigger an image capture operation. Instead, the first camera 531 is configured to capture a plurality of first images respectively separated by known first intervals, and the second camera 532 is configured to capture a plurality of second images respectively separated by known second intervals. An interval may be “known” if it is based on pre-capture knowledge and/or post-capture knowledge. In some examples, the known intervals may vary between image captures and thus not constant (e.g., if the speed of the transport device 510 is not constant). Thus, even in implementations in which the system 500a/b includes an object detection device, the object detection device is not used to trigger the first camera 531 and the second camera 532.

Various components of the system 500a and the system 500b are illustrated as separate entities for ease of explanation, but the present disclosure is not so limited. In examples, the first camera 531, the second camera 532, the signaling device 540 (if present), and the processor 550 may be combined into a single housing to provide a unitary inspection apparatus. In other examples, one or more of the first camera 531, the second camera 532, the signaling device 540 (if present), or the processor 550 may be a separate entity to provide a modular inspection apparatus. In still other examples, each of the first camera 531, the second camera 532, the signaling device 540 (if present), and the processor 550 may be separate entities. In some implementations of the system 500a, the signaling device 540 may be replaced by a software component (e.g., implemented on another device, such as the first camera 531, the second camera 532, another camera, a dimensioner, etc.), which is capable of determining a position of the object 520, a position of a leading edge of the object 520, a position of the trailing edge of the object 520, or combinations thereof. Where the first camera 531, second camera 532, or other device performs the function of the signaling device 540 in such examples, it may in some examples do so in conjunction with the processor 550. In one particular example of an implementation of the system 500b in which a separate signaling device 540 is omitted, the first camera 531 and/or the second camera 532 may include a first image sensor configured to capture relatively high-speed and low-resolution images and a second image sensor configured to capture relatively low-speed and high-resolution images, in which “relative” is with respect to the other image sensor. The first and second image sensors may be included in the same housing or device, or in separate housings or devices. In this example, the images captured by the first image sensor may be used to indicate the location of the object relative to the portion of the transport device 510 within the first field of view 535 and/or the second field of view 536, and the images captured by the second image sensor may be used to perform inspection.

The first camera 531, the second camera 532, the signaling device 540 (if present), and the processor 550 may be connected to one another by wired communication links, by wireless communication links, or both. Wired links include Ethernet links, optical fiber links, serial links such as RS-232 or FireWire links, parallel links, PCI links, and the like. Wireless links include Wi-Fi links such as those that implement IEEE 802.11 protocols, including 802.11, 802.11b, 802.11a, 802.11g, 802.11n, 802.11ac, 802.11ax, 802.11be; Bluetooth (R) links, NFC links; and the like.

The transport device 510 may be any device configured to or capable of conveying items thereon. In some examples, the transport device 510 may be a conveyor belt, a roller conveyor, a tray sorter or other sortation system, any other conveyor, a mobile robot, a fork truck, a flatbed truck or trailer, any other device or vehicle for transporting objects, or any combination of the foregoing.

The objects 520 may be any objects that are, or are capable of being, inspected by a machine vision system. For example, the objects 520 may be manufactured parts, packaged goods, raw materials, shipping parcels, foodstuffs, or any other object that may be visually inspected or characterized by non-contact optical inspection. While FIGS. 5A-B illustrate the objects 520 as being substantially cuboids or other rectangular prisms, the present disclosure is not so limited. In practical implementations, the objects 520 may take any shape. Moreover, while FIGS. 5A-B illustrates a plurality of objects 520, the system 500a/b may also operate with only a single object 520.

The first camera 531 and the second camera 532 are mounted above a surface of the transport device 510 and oriented toward the transport device 510. Preferably, the first camera 531 is mounted such that its field of view 535 includes a first portion of the surface of the transport device 510, and the second camera 532 is mounted such that its field of view 536 includes a second portion of the transport device 510. While FIGS. 5A-B illustrates the first and second portion as being distinct and non-overlapping, the first and second portion may partially or entirely overlap. Additionally, while FIGS. 5A-B illustrate the first camera 531 and the second camera 532 being oriented obliquely and in different directions toward the transport device 510, the first camera 531 and the second camera 532 may be oriented in the same direction, and/or one or both of the first camera 531 and the second camera 532 may be oriented directly toward the transport device 510. If the first camera 531 and the second camera 532 are oriented differently from one another, however, the system 500a/b may be capable of imaging additional surfaces of the objects 520. Moreover, as shown in FIGS. 6A-B, the first camera 531 and the second camera 532 may be provided at different points along the width of the transport device 510. Thus, taking FIGS. 5A-B and 6A-B together, it can be seen that the system 500a/b is capable of imaging five surfaces of the object 520. The first camera 531 and/or the second camera 532 may be machine vision cameras capable of capturing 2D images, although preferably the first camera 531 and the second camera 532 are 3D area-scan cameras, such as a 3D-A1000 dimensioning system provided by Cognex Corporation of Natick, Massachusetts. The images captured by the first camera 531 and/or the second camera 532 may be 3D images, 2D images, or both 3D and 2D images in any combination.

The processor 550 may be one or more electronic processors, each of which includes one or more processing cores. The processor 550 may include or be associated with one or more memory elements. The processor 550 may be configured to execute instructions in the form of transitory signals and/or non-transitory computer-readable media, such as the one or more memory elements. By executing the instructions, the processor 550 is configured to cause the system 500a/b to perform one or more operations, including computing processes, image capture processes, image processing processes, inspection processes, and combinations thereof. The inspection processes may include dimensional measurement, detection of defects, determination of an object's location on the transport device, reading codes or characters, or any other inspection process as described herein. While FIGS. 5A-B and 6A-B illustrate a single processor 550 in communication with both the first camera 531 and the second camera 532, each camera may have its own dedicated processor.

The first field of view 535 and the second field of view 536 may be selected to be any size. Preferably, however, the first field of view 535 and the second field of view 536 may be selected such that, in combination, they cover the full width of the transport device 510 at a height greater than or equal to the tallest object 520 to be inspected.

The first camera 531 is configured to acquire a plurality of first images in sequence and the second camera 532 is configured to acquire a plurality of second images in sequence. For implementations in which a given camera is a 3D camera, the acquired images may be point clouds, meshes, range images, depth maps, or any other 3D data representation. Any image of the plurality of images may include any number of objects, including zero, one, more than one, and/or fractions of objects at the boundaries of the first field of view 535 or the second field of view 536. The largest object 520 to be inspected may or may not fit within a single image. Consecutive ones of the plurality of first images are separated by a known first interval and consecutive ones of the plurality of second images are separated by a known second interval. The magnitude of an interval may be considered “known” if it is set prior to image capture, for example by being predetermined or measured, rather than being dynamically determined as is the case in the comparative system. In some implementations, the intervals are time intervals corresponding to a time elapsed between capture of consecutive ones of the plurality of images. The time intervals may be regular, such that the time elapsed is the same or substantially the same between each consecutive pairs of images. Alternatively, the time intervals may be irregular. Where the intervals are irregular, the first camera 531, the second camera 532, or both may be in communication with (e.g., connected via either a wired or wireless connection) an encoder or other device for measuring the distance traveled by the transport device 510, thereby ensuring that the images are acquired at regular intervals of conveyed distance despite being acquired at irregular intervals of time. In some implementations, only the first camera 531 or the second camera 532 may be in communication with an encoder or other device for measuring the distance traveled by the transport device 510, and the other camera may be synchronized to or calibrated by the camera which communicates with the encoder or other device. If the intervals are irregular, the interval may be measured, for example as a time stamp or encoder value associated with each image in the sequence.

In other implementations, the intervals may be distance intervals corresponding to a distance traveled by the transport device between capture of consecutive images. This may be accomplished by acquiring images at equal intervals of time in conjunction with a conveyor moving at a constant speed. Alternatively, one or both of the first camera 531 and the second camera 532 may be in communication with an encoder or other device for measuring the distance traveled by the transport device 510, and may be configured to capture an image when the transport device 510 has moved by an amount corresponding to the first or second distance interval.

In implementations, the processor 550 may be configured to receive the plurality of first images and the plurality of second images. The images may be received, either directly or indirectly, from the first camera 531 and the second camera 532. The processor 550 may be configured to receive a signal from the signaling device 540 (if present), wherein the signal is configured to indicate that an object 520 is present on the first portion of the transport device 510 (e.g., a portion of the transport device 510 within the first field of view 535) and/or on the second portion of the transport device 510 (e.g., a portion of the transport device 510 within the second field of view 536) or to indicate a location of the object 520 relative to the first and/or second portions of the transport device 510. The processor 550 is configured to, based on the signal, extract image data associated with the object 520 from the plurality of first and/or images, and to inspect the object 520 based on the image data. For example, the processor 550 may be configured to extract image data from the sequence of first images provided by the first camera 531 based on the signal, and may be configured to extract additional image data from the sequence of second images provided by the second camera 532. The extraction of additional image data may also be based on the signal, or may be based on a calibration between the first camera 531 and the second camera 532. The processor 550 may additionally be configured to combine at least two of the plurality of images to yield a resultant image. In some implementations, the resultant image includes a larger portion of the object than individual ones of the plurality of first images or the plurality of second images. For example, the resultant image may sample a larger sampling area than any single image, may include sides of the object 520 within the same sampling area or volume which would be occluded in a single image, or both. The processor 550 may be configured to detect the presence of the object 520 in the resultant image, and to inspect the object 520 based on the resultant image.

Because both the first camera 531 and the second camera 532, as well as any additional cameras, are acquiring a sequence of images containing the object 520, the cameras can be arranged in a way that the object coverage is maximized while the camera number within the system is minimized. As used herein “object coverage” refers to how much of an object 520 (e.g., how many sides) are included in the sequences of images of the multiple cameras. The image sequence of one camera may contain only one object side or it may contain multiple object sides. For example, taking FIGS. 5A-B and 6A-B together, it can be seen that the system 500a/b is capable of imaging five surfaces of the cuboidal object 520 with only two cameras. This is accomplished by arranging one camera in the direction of motion of the transport device 510 and the other camera arranged opposite the direction of motion of the transport device 510. However, in other implementations more cameras than the minimum number may be provided.

The system 500a/b provides several benefits over comparative systems, such as multi-camera variations of the comparative system 100. Similar to the benefits described above with regard to the system 200a/b, for example, inspections may be repeated for each image of the object 520, thereby providing increased precision, accuracy, and/or confidence in the inspection result. Moreover, different images of the same object 520 may include view of the object 520 under different lighting conditions. Thus, in instances where the quality of images provided by the first camera 531 and the second camera 532 is dependent on the lighting conditions and the lighting conditions vary throughout the first field of view 535 and the second field of view, the multiple images may result in inspections that are more precise, accurate, and/or robust. Furthermore, the presence of multiple images may provide increased sampling density on the surface of the object 520, leading to improved inspection results. Additionally, if a portion of an object 520 is occluded in one image, additional images may provide the ability to visualize the occluded portion of the object 520.

Additionally, in multi-camera variations on the comparative system 100, each camera of the multi-camera system acquires an image based on a trigger signal coming from a trigger signal source. Thus, each camera must be synchronized against the trigger signal and/or multiple cameras must be synchronized against each other, thereby to ensure that the object of interest is within the field of view of each camera. In contrast, in system 500a/b the first camera 531 and the second camera 532 need not be synchronized to one another. The first camera 531 and the second camera 532, as well as any additional cameras if present, may acquire images at the same time, at different times, or at any arbitrary time. All cameras of the system 500a/b may share the same image acquisition rate or may have an individual image acquisition rate. Thus, in the system 500a/b, the second interval may be different from and/or independent of the first interval, with each camera producing a sequence of images for each object 520 on the transport device 510 independently.

Moreover, in multi-camera variations on the comparative system 100, the respective fields of view of the multiple cameras commonly overlap such that each camera acquires an image of the object at nearly the same time. This may be necessary in the multi-camera variations on the comparative system 100 to ensure that the object is within the respective field of view of each camera and thus guarantee synchronization between the acquired images. However, if the inspection process requires the projection of any kind of light pattern, such as the symbolic light systems described above, each of the multiple cameras must be synchronized further to ensure that only one camera is acquiring an image at a given time. By contrast, in system 500a/b, there is no requirement that the first field of view 535 and the second field of view 536, as well as any additional fields of view, overlap. In fact, as shown in FIG. 5, the fields of view may be mutually exclusive. Thus, in the system 500a/b, the first camera 531 and the second camera 532, as well as any additional cameras, may acquire images at exactly the same time or at different times.

In the systems and methods described herein, the sequence of images acquired forms a representation of the entire transport device as it passes through the field(s) of view of the camera(s), including the objects being conveyed. Each system includes a processor, which is configured to detect the presence of objects in the sequence of images. The detection of objects may be based solely on the image data, or it may include the use of an object detection device, such as a photocye, which provides a signal indicating that an object, or a portion thereof such as a leading or trailing edge, is at a specific location on the conveyor at a specific moment in time. Examples of methods for detecting objects based solely on the image data include connected components analysis in two or three dimensions, point cloud segmentation algorithms such as cluster extraction or region growing segmentation, or neural-network-based methods such as instance segmentation.

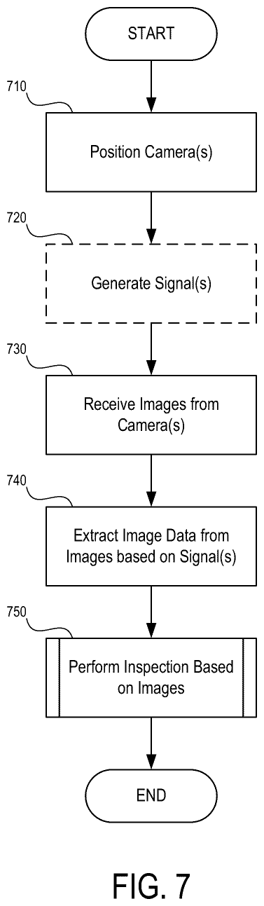

Referring to FIG. 7, a process flow of a method in accordance with the present disclosure is illustrated. The process flow and operations included therein may be performed by various systems in accordance with the present disclosure, including but not limited to the system 200a/b of FIGS. 2A-B or the system 500a/b of FIGS. 5A-B. Thus, in examples the operations may be performed by the processor 250 and/or the processor 550. However, in implementations in which the system includes multiple processors and/or multiple processing cores, certain portions of the operations may be performed by or under the control of different processors or processing cores in any combination. In general, any of the operations may be performed in response to a non-transitory computer-readable medium storing instructions that, when executed by at least one processor of an inspection system, cause the inspection system to perform operations described herein. Moreover, any of the operations may be performed in response to a transitory signal which, when received by or executed by at least one processor of an inspection system, cause the inspection system to perform operations described herein.

The method of FIG. 7 begins with an operation 710 of positioning a camera or, in a multi-camera system, positioning the multiple cameras. For example, operation 710 may include positioning a first 3D area-scan camera above the transport device such that a first portion of the transport device is within a field of view of the first 3D area-scan camera. In multi-camera implementations, operation 710 may further include positioning a second 3D area-scan camera above the transport device such that a second portion of the transport device is within a field of view of the second 3D area-scan camera. In such implementations, the first portion may partially or fully overlap the second portion, or the first and second portions may be non-overlapping.

In implementations in which a signaling device is provided (e.g., the system 200a and/or the system 500b), the method continues with an operation 720 of generating one or more signals. For example, operation 720 may include generating a signal, wherein the signal is configured to indicate a location of the object relative to the first portion of the transport device. In multi-camera systems, operation 720 may include a single operation of generating a signal which is applied to images captured by all cameras, or may include individual operations of generating a respective signal that is applied to images captured by only some of the cameras. In implementations in which no signaling device is present (e.g., the system 200b and/or the system 500b), operation 720 may be omitted.

In either case, the method continues with an operation 730 of receiving images from the camera or, in a multi-camera system, receiving respective sets of images from the multiple cameras. For example, operation 730 may include receiving a sequence of first images captured by the first 3D area-scan camera, wherein consecutive ones of the sequence of first images are separated by known first intervals. In multi-camera implementations, operation 730 may further include receiving a sequence of second images from the second 3D area-scan camera, wherein consecutive ones of the sequence of second images are separated by known second intervals. The first interval and second interval may respectively be distance intervals corresponding to a distance traveled by the transport device between consecutive ones of the sequence of first images, or may be time intervals corresponding to a time elapsed between consecutive ones of the sequence of first images. The first interval and the second interval may be related to one another, dependent on one another, or independent of one another. Where either interval is a distance interval, the magnitude of either interval may be such that, between the capture of consecutive ones of the sequence of first images, the transport device moves a distance that is less than or equal to a length of the field of view of the camera measured at a predetermined height above a surface of the transport device. For example, as described above, the distance may be (1/n) times the length L_{fov}, wherein n is an integer or non-integer greater than or equal to one.

The method continues with an operation 740 of extracting image data from the images based on the one or more signals. For example, operation 740 may include, based on the signal, extracting image data associated with the object from the sequence of first images. In multi-camera implementations, operation 740 may further include extracting additional image data associated with the object from the sequence of second images. In such implementations, the extraction of additional image data may be performed based on the signal or not (e.g., performed based on a calibration between the first and second cameras). Where a calibration process is performed, operation 740 may include calibrating the second 3D area-scan camera based on the first 3D area-scan camera, or vice versa.

The method continues with an operation 750 of performing an inspection based on the images. For example, operation 750 may include inspecting the object based on the image data or, in multi-camera implementations, based on the image data and additional image data. Inspecting the object may include dimensional measurement, detection of defects, determination of an object's location on the transport device, reading codes or characters, or any other inspection process as described herein. Operation 750 may further include detecting an object in the sequence of images, after which further image processing may be applied to the image data to perform the inspections. Inspections may be based on the sequence of images in multiple ways. For example, one image from the sequence may be selected to perform the inspection. In another example, the inspection may be performed on multiple distinct images, either from the same sequence or from different sequences in multi-camera systems, each distinct image containing a representation of the object being inspected. In yet another example, portions of two or more images from the sequence, or from multiple sequences in multi-camera systems, may be merged to form a composite image or resultant image, and the composite or resultant image may be used to perform the inspection. When performing an inspection using either a single image or a resultant image, the entire image may be used to perform the inspection; alternatively, a sub-image may be extracted prior to performing the inspection. The sub-image may be a section of an image containing an object to be inspected. In some embodiments, the term “sub-image” may refer to a portion (e.g., subset) of data associated with an image (e.g., a single image, composite or resultant image, etc.)

In some implementations, after an iteration of operation 750, the method may return to operation 720 or operation 730 to perform continuous or continual operations of receiving images, extracting data, and performing inspections.

The operations illustrated in FIG. 7 need not be performed one after the other in the order illustrated. In some implementations, certain operations may be performed a single time while other operations are performed multiple times. Moreover, certain operations may be performed continuously while other operations are performed. For example, operation 710 may be performed only a single time, either at the beginning of an inspection process or prior to the inspection process, such as during an installation process. Thereafter, operation 720 (if present) may be continuously performed to continuously generate one or more signals, during which time operations 730 through 750 may be performed any number of times. Additionally, some operations may be performed in parallel with other operations. For example, operation 750 may be performed for one set of images and image data while operation 740 is simultaneously performed for a next set of images and image data. In multi-processor and multi-core systems, the parallel operations may be performed by the same processor or core, or by different processors or cores.

In the above systems and methods, the number of objects that may be detected in the sequence of images is independent of the rate at which the images are acquired. It is therefore possible to inspect objects at a rate that exceeds the image acquisition rate of the camera. Merely by way of example, consider a particular example in which a conveyor moves at a speed of 4 m/s (v), the angular field of view of the camera is 60° along the direction of conveyor motion, the tallest object to be inspected is 1 m high (Hₘₐₓ), the smallest object to be inspected is a cube with 100 mm sides (Lₘᵢₙ), the smallest gap between objects is 50 mm (Gₘᵢₙ), the mounting height of the camera above the conveyor is 2 m, and the camera is a 3D area-scan camera with a maximum acquisition rate of 7 frames per second (fps). These parameters imply a maximum object rate (Rₘₐₓ) of 26.67 objects per second, and a length L_{fov} of 1.15 m. In the comparative systems, the cameras would not be able to capture images quickly enough to perform adequate inspection because the maximum object rate is many times larger than the maximum acquisition rate. However, in the systems and methods described herein, by setting the interval to one-half of 1.15 (i.e., L_{fov}/2), an image is acquired for every 0.577 m of belt motion. The corresponding frame rate is 6.93 fps, which is within the capabilities of the camera. Thus, more generally, the invention enables the inspection of objects that exceed the acquisition rate of the camera.

Implementation examples are described in the following numbered clauses:
1. A system for inspecting an object moving on a transport device, the system comprising: a signaling device configured to output a signal indicative of a location of the object relative to a portion of the transport device; a 3D area-scan camera having a field of view (FOV) and positioned to include the portion of the transport device within the FOV, and configured to capture images in accordance with a known interval and irrespective of the signal; and at least one processor in communication with the signaling device and the 3D area-scan camera, and configured to: receive the images, based on the signal, extract image data associated with the object from the images, and analyze the image data and provide an inspection result corresponding to the object.
2. The system of clause 1, wherein the known interval is a distance interval corresponding to a distance traveled by the transport device between consecutive captures of the images.
3. The system of or clause 2, wherein the distance traveled is less than or equal to a length of the FOV of the 3D area-scan camera, as measured at a predetermined distance from the transport device.
4. The system of clause 3, wherein the distance traveled is (1/n) times the length of the FOV, wherein n is an integer greater than or equal to one.
5. The system of clause 1, wherein the known interval is a time interval corresponding to a time elapsed between consecutive captures of the images.
6. The system of any one of clauses 1 to 5, wherein the 3D area-scan camera is positioned such that the images include an area of space spanning a width that is equal to or greater than a transport device width, the width measured at a height above a surface of the transport device that is equal to or greater than a maximum expected height of the object.
7. The system of any one of clauses 1 to 6, wherein the signaling device includes a photoeye.
8. The system of any one of clauses 1 to 7, wherein the at least one processor is in communication with an encoder configured to output a signal indicative of a distance traveled by the transport device.
9. The system of any one of clauses 1 to 8, wherein the 3D area-scan camera is a first 3D area-scan camera configured to capture first images, the system further comprising: a second 3D area-scan camera having a FOV and positioned to include a second portion of the transport device within the second FOV, and configured to capture second images in accordance with a second known interval.
10. The system of clause 9, wherein the at least one processor is configured to: receive the second images, extract additional image data associated with the object from the second images, and analyze the image data and the additional image data and provide the inspection result corresponding to the object.
11. The system of clause 9 or clause 10, wherein the at least one processor is configured to combine one or more of the first images and one or more of the second images to yield a resultant image.
12. The system of any one of clauses 9 to 11, wherein the second known interval is independent of the known interval.
13. The system of any one of clauses 1 to 12, wherein the known interval is predetermined.
14. The system of any one of clauses 1 to 13, wherein the at least one processor is configured to combine multiple first images to yield a resultant image.
15. The system of clause 14, wherein the at least one processor is configured to: detect the presence of the object in the resultant image, wherein the inspection result corresponds to the detected object based on the resultant image.
16. A method for inspecting an object moving on a transport device, the method comprising: generating a signal indicative of a location of the object relative to a first portion of the transport device; receiving images captured by a 3D area-scan camera, the 3D area-scan camera having a field of view (FOV) and being positioned to include the portion of the transport device within the FOV, wherein consecutive images are captured in accordance with a known interval irrespective of the signal; based on the signal, extracting image data associated with the object from the images, and analyzing the image data and providing an inspection result corresponding to the object.
17. The method of clause 16, wherein the known interval is a distance interval corresponding to a distance traveled by the transport device between consecutive captures of the images.
18. The method of or clause 17, wherein the magnitude of the distance interval is such that, between consecutive captures of the images, the transport device travels a distance that is less than or equal to a length of the FOV of the 3D area-scan camera, as measured at a predetermined distance from the transport device.
19. The method of clause 18, wherein the distance traveled is (1/n) times the length of the FOV, wherein n is greater than or equal to one.
20. The method of clause 16, wherein the known interval is a time interval corresponding to a time elapsed between consecutive captures of first the images.
21. The method of any one of clauses 16 to 20, further comprising: combining at least two of the sequence of first images to yield a resultant image, wherein analyzing providing the inspection result is based on the resultant image.
22. The method of any one of clauses 16 to 21, further comprising: extracting, from at least one of the images, a sub-image containing the object, wherein analyzing and providing the inspection result is based on the extracted sub-image.
23. The method of any one of clauses 16 to 22, further comprising: identifying the object and an additional object in an image, wherein analyzing and providing the inspection result is based on the image corresponding to the object and the additional object.
24. The method of any one of clauses 16 to 23, wherein the 3D area-scan camera is a first 3D area-scan camera configured to capture first images, the method further comprising: receiving second images captured by a second 3D area-scan camera, the second 3D area-scan camera having a second FOV and being positioned to include a second portion of the transport device within the second FOV, wherein consecutive second images are captured in accordance with a second known interval irrespective of the signal; and based on the signal, extracting additional image data associated with the object from the second images wherein analyzing the image data and providing the inspection result corresponding to the object includes analyzing the additional image data.
25. The method of any one of clauses 16 to 24, wherein the second known interval is independent of the known interval.
26. The method of clause or clause 25, further comprising: calibrating the second 3D area-scan camera based on the first 3D area-scan camera.
27. The method of any one of clauses 24 to 26, further comprising: combining one or more of the first images and one or more of the second images to yield a resultant image, wherein analyzing and providing the inspection result is based on the resultant image.
28. A non-transitory computer-readable medium storing instructions that, when executed by at least one processor of an inspection system, cause the inspection system to perform operations comprising the method of any one of clauses 16 to 27.
29. A system for inspecting an object moving on a transport device, the system comprising: a 3D area-scan camera having a field of view (FOV) and positioned to include a portion of the transport device within the FOV, and configured to capture a images in accordance with a known interval; and at least one processor in communication with the 3D area-scan camera, and configured to: receive the images, combine multiple of the images to yield a resultant image, extract image data associated with the object from the resultant image, and analyze the image data and provide an inspection result corresponding to the object.
30. The system of clause 29, wherein the known interval is a distance interval corresponding to a distance traveled by the transport device between consecutive captures of the images.
31. The system of or clause 30, wherein the distance traveled is less than or equal to a length of the FOV of the first 3D area-scan camera, as measured at a predetermined distance from the transport device.
32. The system of clause 31, wherein the distance traveled is (1/n) times the length of the FOV, wherein n is an integer greater than or equal to one.
33. The system of clause 29, wherein the known interval is a time interval corresponding to a time elapsed between consecutive captures of images.
34. The system of any one of clauses 29 to 33, wherein the 3D area-scan camera is positioned such that the images include an area of space spanning a width that is equal to or greater than a transport device width, the width measured at a height above a surface of the transport device that is equal to or greater than a maximum expected height of the object.
35. The system of any one of clauses 29 to 34, wherein the at least one processor is in communication with an encoder configured to output a signal indicative of a distance traveled by the transport device.
36. The system of any one of clauses 29 to 35, wherein the 3D area-scan camera is a first 3D area-scan camera configured to capture first images, the system further comprising: a second 3D area-scan camera having a second FOV and positioned to include a second portion of the transport device within the second FOV, and configured to capture second images in accordance with a second known interval.
37. The system of clause 36, wherein the at least one processor is configured to: receive the second images, wherein combining multiple of the images to yield the resultant image includes combining at least one of the first images with at least one of the second images.
38. The system of clause 36 or clause 37, wherein the second known interval is independent of the known interval.
39. The system of any one of clauses 29 to 38, wherein the known interval is predetermined.
40. The system of any one of clauses 29 to 39, wherein the at least one processor is configured to: detect the presence of the object in the resultant image, and provide an inspection result corresponding to the detected object based on the resultant image.
41. The system of any one of clauses 1 to 15, wherein a position of the signaling device relative to the transport device is independent of a position of the 3D area-scan camera.
42. The system of any one of clauses 1 to 15 or clause 41, wherein a position of the signaling device with respect to the transport device is downstream of the 3D area-scan camera, a direction of travel of the transport device.
43. The system of any one of clauses 1 to 15, clause 41, or clause 42, wherein the signaling device is configured to output the signal after capture of the images.
44. A method for inspecting an object moving on a transport device, the method comprising: receiving images captured by a 3D area-scan camera, the 3D area-scan camera having a field of view (FOV) and being positioned to include a portion of the transport device within the FOV, wherein consecutive images are captured in accordance with a known interval; combining multiple images to yield a resultant image; extracting image data associated with the object from the resultant image; and analyzing the image data and providing an inspection result corresponding to the object.
45. The method of clause 44, wherein the known interval is a distance interval corresponding to a distance traveled by the transport device between consecutive captures of the images.
46. The method of clause 45, wherein the magnitude of the distance interval is such that, between consecutive captures of the images, the transport device travels a distance that is less than or equal to a length of the FOV of the 3D area-scan camera, as measured at a predetermined distance from the transport device.
47. The method of clause 46, wherein the distance traveled is (1/n) times the length of the FOV, wherein n is an integer greater than or equal to one.
48. The method of clause 44, wherein the known interval is a time interval corresponding to a time elapsed between consecutive captures of images.
49. The method of any one of clauses 44 to 48, wherein the 3D area-scan camera is positioned such that the images include an area of space spanning a width, measured at a height above a surface of the transport device that is equal to or greater than a tallest height of the object, that is equal to or greater than a width of the transport device.
50. The method of any one of clauses 44 to 49, further comprising: receiving, from an encoder, a signal indicative of a distance traveled by the transport device.
51. The method of any one of clauses 44 to 50, wherein the 3D area-scan camera is a first 3D area-scan camera configured to capture first images, the method further comprising: receiving second images captured by a second 3D area-scan camera, the second 3D area-scan camera having a second FOV and being positioned to include a second portion of the transport device within the second FOV, wherein consecutive second images are captured in accordance with a second known interval.
52. The method of clause 51, further comprising: extracting additional image data associated with the object from the second images, wherein analyzing the image data and providing the inspection result corresponding to the object includes analyzing the additional image data.
53. The method of clause 51 or clause 52, further comprising: combining one or more of the first images and one or more of the second images to yield the resultant image.
54. The method of any one of clauses 51 to 53, wherein the second known interval is independent of the known interval.
55. The method of any one of clauses 44 to 54, wherein the known interval is predetermined.
56. A non-transitory computer-readable medium storing instructions that, when executed by at least one processor of an inspection system, cause the inspection system to perform operations comprising the method of any one of clauses 44 to 55.

The particular aspects disclosed above are illustrative only, as the technology may be modified and practiced in different but equivalent manners apparent to those skilled in the art having the benefit of the teachings herein. Furthermore, no limitations are intended to the details of construction or design herein shown, other than as described in the claims below. It is therefore evident that the particular aspects disclosed above may be altered or modified and all such variations are considered within the scope and spirit of the technology. Accordingly, the protection sought herein is as set forth in the claims below.

What is claimed is:

1. A system for inspecting an object moving on a transport device, the system comprising:
a signaling device configured to output a signal indicative of a location of the object relative to a portion of the transport device;
a 3D area-scan camera having a field of view (FOV) and positioned to include the portion of the transport device within the FOV, and configured to capture images in accordance with a known interval and irrespective of the signal; and
at least one processor in communication with the signaling device and the 3D area-scan camera, and configured to:
receive the images,
based on the signal, extract image data associated with the object from the images, and
analyze the image data and provide an inspection result corresponding to the object.

2. The system of claim 1, wherein the known interval is a distance interval corresponding to a distance traveled by the transport device between consecutive captures of the images.

3. The system of claim 2, wherein the distance traveled is less than or equal to a length of the FOV of the 3D area-scan camera, as measured at a predetermined distance from the transport device.

4. The system of claim 3, wherein the distance traveled is (1/n) times the length of the FOV, wherein n is an integer greater than or equal to one.

5. The system of claim 1, wherein the 3D area-scan camera is positioned such that the images include an area of space spanning a width that is equal to or greater than a transport device width, the width measured at a height above a surface of the transport device that is equal to or greater than a maximum expected height of the object.

6. The system of claim 1, wherein the at least one processor is in communication with an encoder configured to output a signal indicative of a distance traveled by the transport device.

7. The system of claim 1, wherein the 3D area-scan camera is a first 3D area-scan camera configured to capture first images, the system further comprising:
a second 3D area-scan camera having a second FOV and positioned to include a second portion of the transport device within the second FOV, and configured to capture second images in accordance with a second known interval.

8. The system of claim 7, wherein the at least one processor is configured to:
receive the second images,
extract additional image data associated with the object from the second images, and
analyze the image data and the additional image data and provide the inspection result corresponding to the object.

9. The system of claim 8, wherein the at least one processor is configured to combine one or more of the first images and one or more of the second images to yield a resultant image.

10. The system of claim 7, wherein the second known interval is independent of the known interval.

11. A method for inspecting an object moving on a transport device, the method comprising:
generating a signal indicative of a location of the object relative to a portion of the transport device;
receiving images captured by a 3D area-scan camera, the 3D area-scan camera having a field of view (FOV) and being positioned to include the portion of the transport device within the FOV, wherein consecutive images are captured in accordance with a known interval irrespective of the signal;
based on the signal, extracting image data associated with the object from the images, and
analyzing the image data and providing an inspection result corresponding to the object.

12. The method of claim 11, wherein the known interval is a distance interval corresponding to a distance traveled by the transport device between consecutive captures of the images.

13. The method of claim 12, wherein the magnitude of the known interval is such that, between consecutive captures of the images, the transport device travels a distance that is less than or equal to a length of the FOV of the 3D area-scan camera, as measured at a predetermined distance from the transport device.

14. The method of claim 13, wherein the distance traveled is (1/n) times the length of the FOV, wherein n is greater than or equal to one.

15. The method of claim 11, further comprising:
combining at least two images to yield a resultant image,
wherein analyzing and providing the inspection result is based on the resultant image.

16. The method of claim 11, further comprising:
extracting, from at least one of the images, a sub-image containing the object, wherein analyzing and providing the inspection result is based on the sub-image.

17. The method of claim 11, further comprising:
identifying the object and an additional object in an image,
wherein analyzing and providing the inspection result based on the image corresponds to the object and the additional object.

18. The method of claim 11, wherein the 3D area-scan camera is a first 3D area-scan camera configured to capture first images, the method further comprising:
receiving second images captured by a second 3D area-scan camera, the second 3D area-scan camera having a second FOV and being positioned to include a second portion of the transport device within the second FOV, wherein consecutive second images are captured in accordance with a second known interval irrespective of the signal;
based on the signal, extracting additional image data associated with the object from the second images,
wherein analyzing the image data and providing the inspection result corresponding to the object includes analyzing the additional image data.

19. The method of claim 18, further comprising:
calibrating the second 3D area-scan camera based on the first 3D area-scan camera.

20. A non-transitory computer-readable medium storing instructions that, when executed by at least one processor of an inspection system, cause the inspection system to perform operations comprising the method of claim 11.
